(19) United States
(12) Patent Application Publication
(10) Pub. No.: US 2006/0129651 A1
(43) Pub. Date: Jun. 15, 2006

(54) Methods, systems, and storage mediums for allowing some applications to read messages while others cannot due to resource constraints in a system

(75) Inventors: Jamie Farmer, Beacon, NY (US); Mark Richard Gambino, Brewster, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: International Business Machines Corporation, Armonk, NY (US)

(21) Appl. No.: 11/012,807

(22) Filed: Dec. 15, 2004

(51) Int. Cl. G06F 15/16

(52) U.S. Cl. 709/207

(57) ABSTRACT

When running network applications, resources are made available in a system having resource constraints. While messages are being received, a method adjusts the priorities of incoming messages, avoiding driving the system out of resources. In some environments, it is desirable for some important applications to continue to process data from the network. Often, the system is waiting for a response or acknowledgement from a remote application. This can result in a deadlock or shutdown condition. A method provides the ability to classify inbound messages as high priority messages and process the high priority messages at all times. A server is updated to poll the network, even when it is in shutdown mode.

### BACKGROUND OF THE INVENTION

1. Field of the Invention

The present invention relates generally to computer and processor architecture, network computing, data coding and encoding, data assembly and formatting and, in particular, to operating systems with the ability to run transmission control protocol/Internet protocol (TCP/IP) server applications.

2. Description of Related Art

A computer acting as a server for many clients can go into shutdown mode due to constraints on the system. When this happens, the server stops polling (reading from) the network, until enough resources are available to do so. The reasons for a system to enter shutdown mode are implementation dependent.

When a computer enters shutdown mode due to resource constraints, the system will not read any information from the network. This is to avoid any new work from entering the system and possibly driving the system completely out of resources.

However, in some situations, it is desirable for certain business critical applications to continue to process data from the network, even when the system is in shutdown mode. Furthermore, many times, response data from the network or a remote application, client, or operator is exactly what the system needs to free up enough resources to exit shutdown mode.

For example, suppose an application is holding onto messages sent, waiting for an acknowledgement from a remote application. These resources cannot be freed until the response from the network is received. This can result in a deadlock condition causing the server to be shutdown. Then, the only way out of shutdown is for the server to free its resources, but this cannot happen because the response cannot be received in shutdown mode. In this example, it would be desirable to read the acknowledgement from the network for this application, but not read other traffic (e.g., new work) that would further deplete server resources.

### BRIEF SUMMARY OF THE INVENTION

The present invention is directed to methods, systems, and storage mediums for allowing some applications to read messages while others cannot due to resource constraints in a system that satisfies these needs and others.

A first aspect is a method for allowing select applications to read messages while other applications cannot due to resource constraints. A message is received from a network. The message is destined for an application. The message is classified as a high priority message. The message is passed to the application, while in shutdown mode. Another aspect is a storage medium storing instructions for performing this method.

Another aspect is a system for allowing select applications to read messages while other applications cannot due to resource constraints. The system including a transmission control protocol/Internet protocol (TCP/IP) stack that has an application layer, a socket layer, a TCP layer, a user datagram protocol (UDP) layer, an IP layer, a packet classification layer, and a link layer. The link layer receives a message from a network. The packet classification layer classifies the message as a high priority message and the message is passed up to the application layer, while in shutdown mode.

### BRIEF DESCRIPTION OF THE DRAWINGS

These and other features, aspects, and advantages of the present invention will become better understood with regard to the following description, appended claims, and accompanying drawings, where:

FIG. 1 is a block diagram showing where a packet classification layer resides in an exemplary network stack within a server;

FIG. 2 is a block diagram showing where a priority determination is made in the exemplary network stack within the server; and

FIG. 3 is a flow diagram showing an exemplary method of processing a packet.

### DETAILED DESCRIPTION OF THE INVENTION

This exemplary embodiment includes a method that allows the server to classify inbound messages destined for a specific application or network connection, such as a TCP/IP socket, as high priority messages and process those messages at all times. This means that when a high priority message is received by the system, the message will be passed up to the application regardless of the resource level constraints on the system.

In this exemplary embodiment, more than packet classification is performed. There is also the ability to always read and process high priority messages. Some packet classification methods within a server are invoked once a packet is read from a network. When a traditional server is in shutdown mode, no packets are read from the network. Therefore, the existing packet classification layer is not invoked and cannot be used to help get the system out of shutdown mode.

In this exemplary embodiment, select applications, (e.g., business critical applications or applications holding many resources) are allowed to continue to read messages from the network, while the system is in shutdown mode. This eliminates the deadlock situations where resources held by an application drive the server into shutdown mode and the only way to get out of shutdown mode is for data to be received from the network.

In this exemplary embodiment, applications, such as remote operator support, are allowed to work in shutdown mode. For example, a remote operator is still able to send commands over a network in an effort to get the server out of shutdown mode.

In this exemplary embodiment, the server still polls (reads messages from) the network, even in shutdown mode. When a message is received, the packet classification layer determines whether or not the input packet is high priority. Many different methods may be used to classify inbound packets as high or other priority.

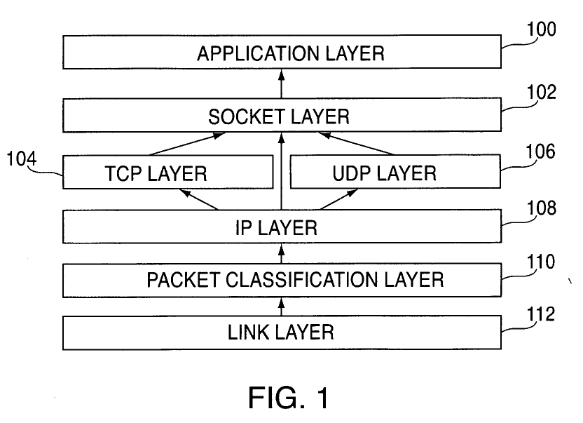

FIG. 1 shows where a packet classification layer resides in an exemplary network stack within a server. In this example, a TCP/IP stack is used, but many other types of communications may be used in various embodiments, such as systems network architecture (SNA), open systems interconnection (OSI) and the like. In this exemplary TCP/IP stack, there is an application layer 100, a socket layer 102, a TCP layer 104, a user datagram protocol (UDP) layer 106, an IP layer 108, a packet classification layer 110, and a link layer 112.

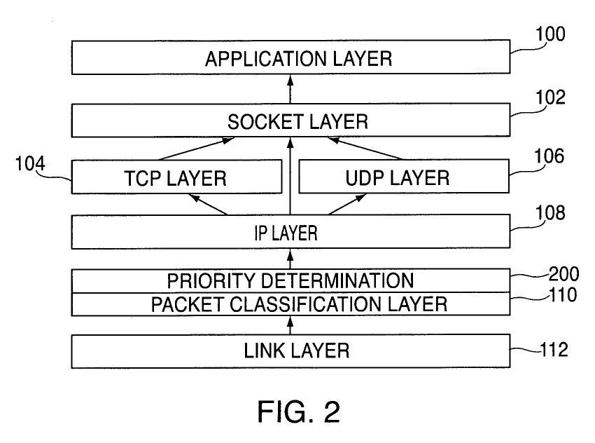

FIG. 2 shows where a priority determination is made in the exemplary network stack within the server. In this exemplary TCP/IP stack, after a packet is classified in the packet classification layer 110, the system determines (priority determination 200) if the packet needs to be introduced to the system based on the priority and whether resources are currently constrained in the system. A packet is introduced to the system by being passed up to the IP layer 108, in this example but may be implemented in various ways.

In this exemplary embodiment, when the system is in shutdown mode, those messages other than high priority message (i.e., low or regular priority messages) are queued and passed to the IP layer 108 to be processed at a later time when the system exits shutdown mode or they are simply discarded. However, when the system is in shutdown mode, high priority messages are passed up to the application layer 100, regardless of the resource constraints.

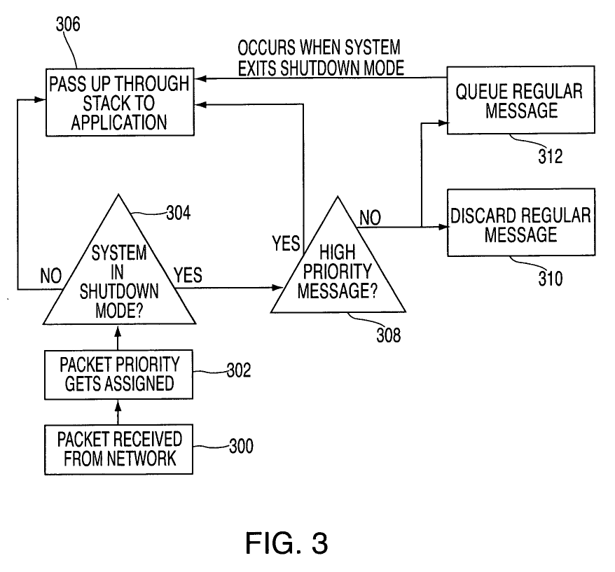

FIG. 3 shows an exemplary method of processing a packet. After, a packet is received from the network at 300, a priority is assigned to the packet at 302. At 304 it is determined whether the system is in shutdown mode. If the system is not in shutdown mode, the packet is passed up through the stack to the application at 306. Otherwise, if the system is in shutdown mode, it is determined whether the packet is a high priority message at 308. If it is a high priority message, the packet is passed up through the stack to the application at 306. Otherwise, if it is not a high priority message, it is either queued at 312 or discarded at 310. When the system exits shutdown mode, the regular (non-high priority) messages that were queued at 312 are passed up through the stack to the application at 306. How the determination of whether to queue or discard is made varies in various embodiments. For example, the server may have a fixed set of buffers for queuing non-high priority packets when in shutdown mode. Then, if a non-high priority packet arrives in shutdown mode and these buffers are full, the packet is discarded; otherwise the packet is queued.

An exemplary embodiment performs a method to allow some applications to read messages while others cannot, due to resource constraints in the system. The server classifies inbound messages destined for a specific application or socket as high priority messages and processes those messages at all times. When a message is classified by the server as having a high priority, it is passed up to the application regardless of the resource level constraints on the system. This allows business critical applications or other applications holding many resources to still read messages from the network while the system is in shutdown mode. This exemplary embodiment eliminates the deadlock situations where resources held by an application drive the server into shutdown mode and the only way to get out of shutdown mode is for data to be received from the network. In addition, exemplary embodiments allow applications, such as a remote operator support to work in shutdown mode. For example, a remote operator is still able to issue commands in an effort to get the server out of shutdown mode. Another example is remote administration, such as where a remote operator may need to stop a queue manager or channel on the server to get the server out of shutdown mode.

There are many ways for a server to classify inbound messages as high priority. Typically, a packet classification layer is placed at the low level of the TCP/IP stack. This packet classifier decides priority of the message based on rules and policy defined in the server. The rules and policy may include the type of message, the destination application for the message, and the destination socket for the packet. The server is updated to poll the network, even when in shutdown mode. Messages that are classified as anything other than high priority (e.g., regular or low priority) are queued by the server and, then, processed, after the server exits shutdown mode. Alternatively, the server may discard these messages. This is the result for servers that do not poll the network when in shutdown mode, i.e. the routers discard the messages. High priority messages are passed to the application, even when the system is in shutdown mode. While the system is in shutdown mode, the system continues to poll from the network. Reading messages from the network during shutdown allows the system to process high priority messages and, in turn, allows applications to continue processing in times of resource constraint. Allowing certain critical messages to be processed often enables the server to reclaim resources and exit shutdown mode.

Exemplary embodiments of the present invention have many advantages, such as eliminating the deadlock situations where resources held by an application drive the server into shutdown mode and the only way to get out of shutdown mode is for data to be received from the network. In addition, exemplary embodiments allow applications, such as a remote operator support to work in shutdown mode. Allowing certain critical messages to be processed often enables the server to reclaim resources and exit shutdown mode.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. For example, various personal items other than types of cards may be used for practicing various embodiments of the present invention. In addition, future improvements or changes to standards may be used with minor adaptations of various embodiments of the present invention. Furthermore, various components may be implemented in hardware, software, or firmware or any combination thereof. Finally, many modifications may be made to adapt a particular situation or material to the teachings of the invention without departing from the essential scope thereof. Therefore, it is intended that the invention is not to be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for allowing select applications to read messages while other applications cannot due to resource constraints, comprising:
receiving a message from a network, the message being destined for an application;
classifying the message as a high priority message; and
passing the message to the application, while in shutdown mode.

2. The method of claim 1, further comprising:
reading the message from the network, while in shutdown mode.

3. The method of claim 1, wherein the application is a remote operator support.

4. The method of claim 3, further comprising:
sending, by the remote operator support, commands over the network.

5. The method of claim 1, further comprising:
polling from the network, while in shutdown mode.

6. A system for allowing select applications to read messages while other applications cannot due to resource constraints, comprising:
a transmission control protocol/Internet protocol (TCP/IP) stack having an application layer, a socket layer, a TCP layer, a user datagram protocol (UDP) layer, an IP layer, a packet classification layer, and a link layer for receiving a message from a network;
wherein the packet classification layer classifies the message as a high priority message and the message is passed up to the application layer, while in shutdown mode.

7. The system of claim 6, wherein an additional message is read from the network, while in shutdown mode.

8. The system of claim 6, further comprising a remote operator support.

9. The system of claim 8, wherein the remote operator support sends a command over the network.

10. The system of claim 6, wherein polling from the network occurs, while in shutdown mode.

11. A storage medium storing instructions for performing a method for allowing select applications to read messages while other applications cannot due to resource constraints, the method comprising:
receiving a message from a network, the message being destined for an application;
classifying the message as a high priority message; and
passing the message to the application, while in shutdown mode.

12. The storage medium of claim 11, wherein the message is a new request from a remote operator.

13. The storage medium of claim 11, wherein the message is an acknowledgement.

14. The storage medium of claim 13, further comprising:
freeing resources, upon processing the acknowledgement.
